(19) United States
(12) Patent Application Publication
(10) Pub. No.: US 2004/0151000 A1
(43) Pub. Date: Aug. 5, 2004

(54) Foldable lampshade frame structure

(76) Inventor: Mei-Ju Juang, ShuLin City (TW)

Correspondence Address: BACON & THOMAS, PLLC, 625 SLATERS LANE, FOURTH FLOOR, ALEXANDRIA, VA, 22314

(21) Appl. No.: 10/358,351

(22) Filed: Feb. 5, 2003

(51) Int. Cl. F21V 11/00; F21V 1/12

(52) U.S. Cl. 362/352; 362/360; 362/358

(57) ABSTRACT

Foldable lampshade frame structure which can be folded to minimize the volume of the lampshade. The lampshade frame structure is covered by a soft lampshade sheet. The frame structure includes a circular upper tray, a circular lower tray and several foldable ribs riveted on circumferences of the upper and lower trays. Each foldable rib is provided with a foldable and movable pivot head near middle portion of the rib, whereby the lampshade frame structure is easily foldable to minimize the volume of the lampshade without affecting the rigidity thereof. Accordingly, the occupied space is greatly reduced so that the transfer and storage of the lampshades are facilitated.

### BACKGROUND OF THE INVENTION

The present invention is related to a foldable lampshade frame structure in which the supporting foldable ribs are foldable to minimize the volume of the lampshade. In mass-production, the transfer of the lampshades is facilitated and the storage space is saved.

A conventional lampshade structure includes a frame and a lampshade sheet covering the frame structure for converging light beam. The frame structure of the conventional lampshade includes metallic rod bodies fixedly connected by welding or fusion to ensure structural strength and safety. Such frame structure cannot be disassembled and has considerably large volume to occupy much room. In mass-production, it is quite inconvenient to store or transfer the lampshades so that the manufacturing cost is indirectly increased.

### SUMMARY OF THE INVENTION

It is therefore a primary object of the present invention to provide a foldable lampshade frame structure which can be easily assembled and folded. Each rib of the lampshade frame structure is provided with a foldable and movable pivot head near middle portion of the rib. By means of the pivot head, the foldable rib can be folded to minimize the volume of the lampshade without occupying much room. Therefore, the transfer of the lampshades is facilitated and the storage space is saved. In addition, the structural strength or rigidity of the lampshade will not be affected.

The present invention can be best understood through the following description and accompanying drawings wherein:

### BRIEF DESCRIPTION OF THE DRAWINGS

FIG. 1 is a perspective exploded view of the present invention;

FIG. 2 shows the foldable rib of the present invention in an unfolded state;

FIG. 3 shows the foldable rib of the present invention in a folded state;

FIG. 4 shows the lampshade frame structure of the present invention in a folded state; and

FIG. 5 is a perspective view of the complete lampshade of the present invention.

### DETAILED DESCRIPTION OF THE PREFERRED EMBODIMENT

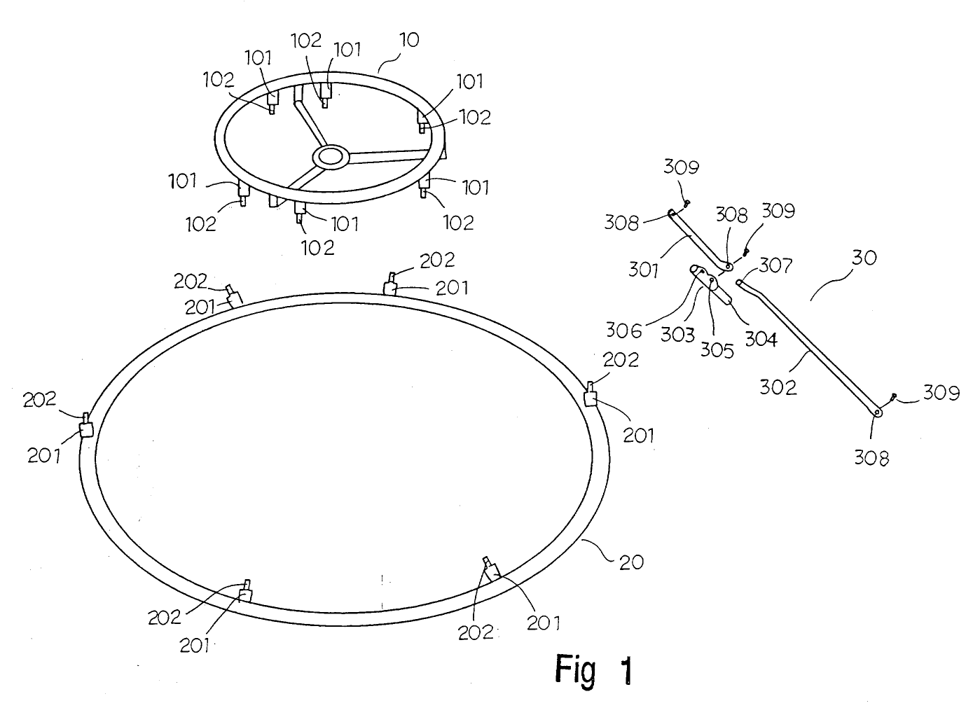

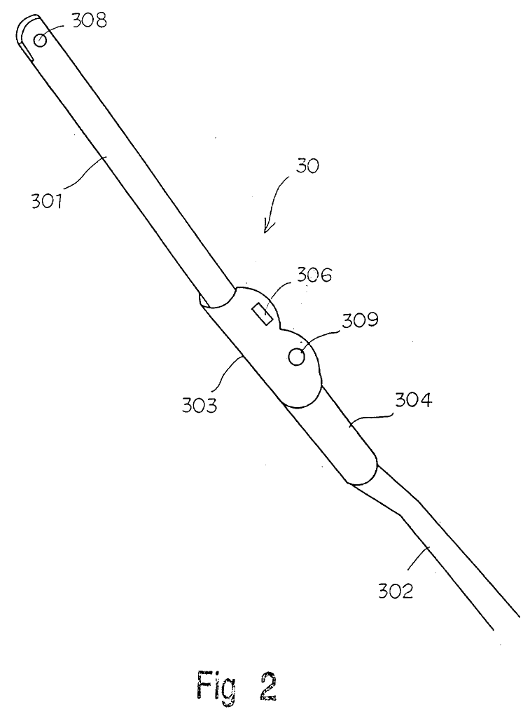

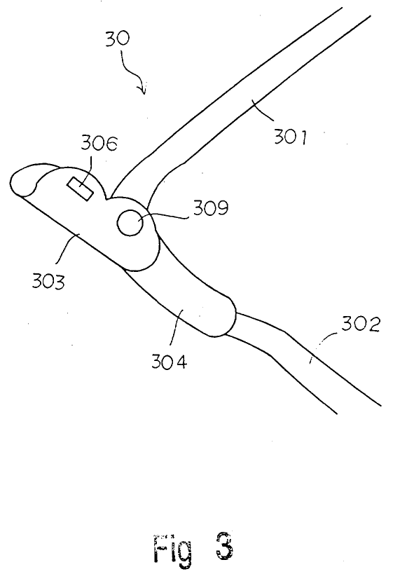

Please refer to FIGS. 1 to 3. The foldable lampshade frame structure 1 of the present invention is disposed in a soft lampshade fabric. The frame structure 1 includes a circular upper tray 10 and a circular lower tray 20 and several foldable ribs 30 riveted on the circumferences of the upper and lower trays 10, 20. Each foldable rib 30 is provided with a foldable and movable pivot head 303 near middle portion of the foldable rib 30, whereby the lampshade frame structure 1 is foldable and collapsible.

The circumference of the upper tray 10 is provided with several connecting posts 101 each having a connecting hole 102. An upper rod 301 of the foldable rib 30 is formed with a rivet hole 308. A rivet 309 is passed through the rivet hole 308 and the connecting hole 102 to movably rivet the foldable rib 30 with the connecting post 101.

The circumference of the lower tray 20 is provided with several connecting posts 201 each having a connecting hole 202. A lower rod 302 of the foldable rib 30 is formed with a rivet hole 308. A rivet 309 is passed through the rivet hole 308 and the connecting hole 202 to movably rivet the foldable rib 30 with the connecting post 201.

The foldable rib 30 is composed of an upper rod 301, a lower rod 302 and a pivot head 303. One end of the upper rod 301 is formed with a rivet hole 308. The rivet 309 is passed through the rivet hole 308 and the connecting hole 102 of the connecting post 101 of the upper tray 10 to movably rivet the upper rod 301 with the connecting post 101. The other end of the upper rod 301 is also formed with a rivet hole 308. Two sides of the pivot head 303 are formed with two fitting holes 305. A rivet 309 is passed through the rivet hole 308 and the fitting holes 305 to movably rivet the upper rod 301 with the pivot head 303. One end of the lower rod 302 is formed with a rivet hole 308. The rivet 309 is passed through the rivet hole 308 and the connecting hole 202 of the connecting post 201 of the lower tray 20 to movably rivet the lower rod 302 with the connecting post 201. The other end of the lower rod 302 is formed with a rivet section 307 which is fixedly riveted with a-rivet plate 304 of the pivot head 303. In addition, two ends of the pivot head 303 are formed with inward recessed locating protuberances 306 opposite to each other for clamping and locating the upper rod 301 when unfolded.

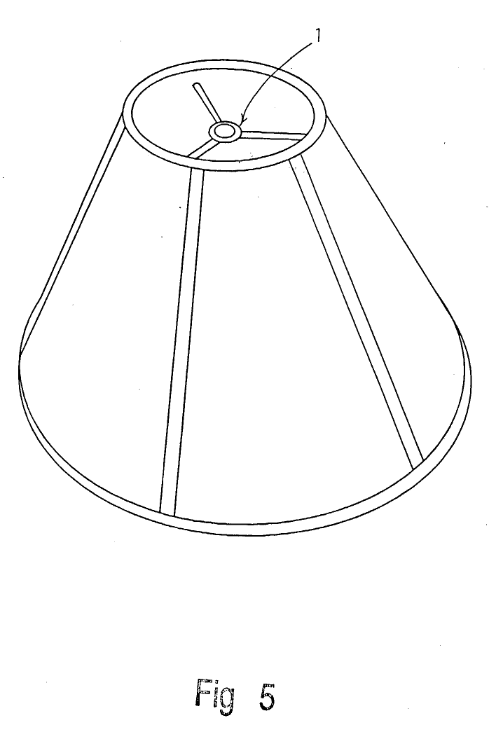

The lampshade is formed of soft fabric, including an inner and an outer layers. The lampshade completely encloses the frame structure 1 therein to achieve a beautiful appearance as shown in FIG. 5.

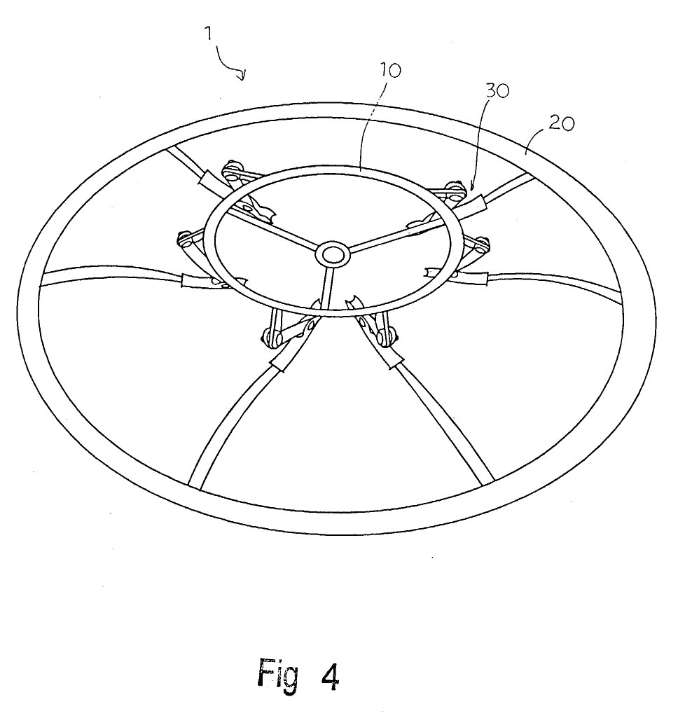

The upper and lower trays 10, 20 and the foldable ribs 30 are assembled to form the solid hollow lampshade frame structure 1 covered by the lampshade fabric. The foldable ribs 30 are independently foldable so that when not used and stored, by means of the pivot head 303, the foldable rib 30 can be folded to minimize the volume of the lampshade without occupying much room. In mass-production, the transfer of the lampshades will be facilitated and the storage space is saved as shown in FIG. 4.

The above embodiment is only used to illustrate the present invention, not intended to limit the scope thereof. Many modifications of the above embodiment can be made without departing from the spirit of the present invention.

What is claimed is:

1. Foldable lampshade frame structure covered by a soft lampshade sheet, the frame structure comprising a circular upper tray, a circular lower tray and several foldable ribs riveted on circumferences of the upper and lower trays, said lampshade frame structure being characterized in that each foldable rib of the lampshade frame structure is provided with a foldable and movable pivot head, whereby the lampshade frame structure is easily foldable to minimize the volume of the lampshade without affecting the rigidity thereof.

2. Foldable lampshade frame structure as claimed in claim 1, wherein two ends of the pivot head are formed with inward recessed locating protuberances opposite to each other for clamping and locating an upper rod of the foldable rib when unfolded.
